(19) United States
(12) Patent Application Publication
(10) Pub. No.: US 2004/0216061 A1
(43) Pub. Date: Oct. 28, 2004

(54) Embeddable method and apparatus for functional pattern testing of repeatable program instruction-driven logic circuits via signal signature generation

(75) Inventors: Michael Stephen Floyd, Austin, TX (US); Larry Scott Leitner, Austin, TX (US)

Correspondence Address: Andrew M. Harris, Weiss, Moy & Harris, P.C., 4204 North Brown Ave., Scottsdale, AZ, 85251-3914, US

(73) Assignee: International Business Machines Corporation, Armonk, NY

(21) Appl. No.: 10/425,398

(22) Filed: Apr. 28, 2003

(51) Int. Cl. G06F 17/50

(52) U.S. Cl. 716/4; 703/15; 324/750

(57) ABSTRACT

An embeddable method and apparatus for functional pattern testing of repeatable program instruction-driven logic circuits via signal signature generation provides an improved mechanism for functional testing of integrated circuits. The apparatus may be embedded within a processor having an exerciser program loaded within an internal cache and includes one or more multiple input shift registers (MISR) coupled to a set of selected internal signal points within functional blocks of the integrated circuit for collecting a signature in response to state changes of the internal signal points caused by execution of the exerciser program. The signature is compared to a known good signature to generate pass/fail or diagnostic information during design/mask evaluation, manufacturing testing, and/or as a screening test during diagnostic boot in a production environment. A logic analyzer may also be implemented using the MISR, providing an efficient mechanism for verifying a lengthy response of logic circuits without requiring a large trace buffer. The exerciser program may be located within a device under test (DUT), external to the DUT, or may be located within the logic analyzer and provided with stimulus outputs for driving state changes of the measured signals in the DUT from the analyzer. The exerciser program may be self-modifying or self-test-case-generating, reducing the code size required to exercise a large pattern through the DUT.

### BACKGROUND OF THE INVENTION

1. Technical Field

The present invention relates generally to logic analysis in circuits having a repeatable behavior controlled by program code, and more particularly, to a program instruction-driven integrated circuit having internal logic testing apparatus for generating signatures from sets of internal signals.

2. Description of the Related Art

Present-day high-speed processors and other complex integrated circuits (ICs), generally known as Very Large Scale Integrated (VLSI) circuits, generally include some form of internal test logic for support of external testers. Level Sensitive Scan Design (LSSD) circuits provide a means for circuit testers to send test vectors and receive results from a production test of an IC. Such techniques typically reuse I/O connections that serve other purposes during actual operation (as opposed to test operation, but most ICs do not have enough I/O pins and most testers do not have enough high-frequency outputs to adequately test present-day VLSI designs. Further, due to the rate of the data transfer between the tester and the IC, it is not possible to test an IC at frequencies approaching operational frequencies.

External test devices such as logic analyzers typically capture signal states in trace buffers before or after a trigger event. Such devices generally and especially at higher clock frequencies cannot include sufficient storage to gather meaningful information about all of the states that may be entered in a complex VLSI IC. Also, the comparison process is typically performed by comparing values received by the logic analyzer input and a known response pattern. As such, a comparison that would yield information about most or all of the output states of a circuit, especially a circuit driven by program instruction control requires not only a large trace buffer, but also significant processing time to determine whether or not the results match an expected pattern.

Built-in self test circuits (BIST) circuits have been provided within VLSI circuits to provide test functionality within ICs, removing some of the limitations of LSSD circuit testing. However, BIST circuits are still typically interfaced with an external tester to provide more extensive test capability where a series of test vectors and expected results are loaded from an external tester and then cycled through a functional unit within the IC. The BIST circuit compares the results from the functional unit with the expected result and flags a failure if the results do not match. However, detecting the exact failure point within a complex IC via this process is slow and typically requires complex algorithms that attempt to identify the actual clock cycle failure point. Further, existing BIST circuitry uses the scan clock, rather than the functional clocks to load and check the test patterns, and therefore cannot perform tests as quickly as they would otherwise be performed by clocking at full operational frequencies.

In order to transcend the above-mentioned limitations, debug versions of ICs (test substrates) have been produced that incorporate more test logic than would be practical in an IC produced for manufacturing in quantities. The internal test facilities provided in the debug ICs enable testing that would otherwise require a prohibitive amount of die area and/or number of I/O connections and I/O transfer time to support an external testing procedure. Internal test facilities also provide test capabilities that would otherwise be impracticable without the use of internal units to self-test the integrated circuits.

In particular, U.S. Pat. Nos. 6,393,594 and 6,438,722, incorporated herein by reference, disclose test methodologies and circuits that provide internal pattern generators, output trace arrays and result checkers to run test patterns through functional logic units within an integrated circuit. However, the test circuits only provide for testing of isolated blocks within the IC and cannot test every internal node of the isolated blocks, therefore it is still not possible to detect all defects within an IC incorporating the methods of the above-referenced patents. Further, prior BIST techniques for testing arrays (ABIST tests) typically cannot test arrays in combination with functional logic, which is tested by a separate facility (LBIST). LBIST cannot generate necessary combinations of read and write array access combinations to sufficiently test the operation of the array at full operational frequencies.

It is therefore desirable to implement a method and apparatus that provide improved testability of internal integrated circuit functional blocks. It is further desirable to provide a method and apparatus that can test array elements and logic in combination. It is also desirable to provide the above-identified test-facilities and improvements in the production version of an integrated circuit. It would further be desirable to provide improvements in a general test apparatus such as a logic analyzer, so that program instruction-driven logic can be evaluated without requiring large trace buffers and processing time to determine the results of an evaluation.

### SUMMARY OF THE INVENTION

The objective of providing improved testability in the production version an integrated circuit that can test storage and logic in combination is accomplished in an integrated circuit and method for testing an integrated circuit. The objective of providing improvements in a general test apparatus is also provided by similar circuitry and an analogous method that reduce the size of state information that must be retained in order to verify that a device under test behaves identically with a known performance.

The apparatus includes a processing element and a set of program instructions for exercising circuits of a device under test (DUT) at functional clock frequencies. The DUT may be the processing element itself and the apparatus may be included within an integrated circuit containing the processing element or may be included within an integrated circuit coupled to the processing element. A set of program instructions for which the response of a set of signals within the DUT are repeatable is provided to the processing element and the processing element is directed to execute the program instructions. The program instructions may be loaded within a cache storage of an integrated circuit that contains the processing element, providing a completely embedded functional test apparatus. The program instructions may also generate their own pseudo-random code streams to apply to the DUT.

The apparatus further includes at least one multiple input shift register (MISR) coupled to nodes bearing the set of signals of the DUT, whereby a signature is collected at periodic intervals of a clock that clocks internal states of the processing element to determine values of the set of signals in conformity with the execution of the program instructions. The collected signature is then compared to a known good signature in order to verify the proper operation of the DUT.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1 is a block diagram of prior art test apparatus within an integrated circuit.

FIG. 2 is a block diagram of another prior art test apparatus within an integrated circuit.

FIG. 3 is a block diagram of a test apparatus within an integrated circuit in accordance with an embodiment of the invention.

FIG. 4 is a block diagram of trace array 37 incorporating MISR 31 of FIG. 3.

FIG. 5 is a block diagram of a test apparatus in accordance with other embodiments of the invention.

FIG. 6 is a flowchart depicting a method in accordance with an embodiment of the present invention.

### DESCRIPTION OF ILLUSTRATIVE EMBODIMENT

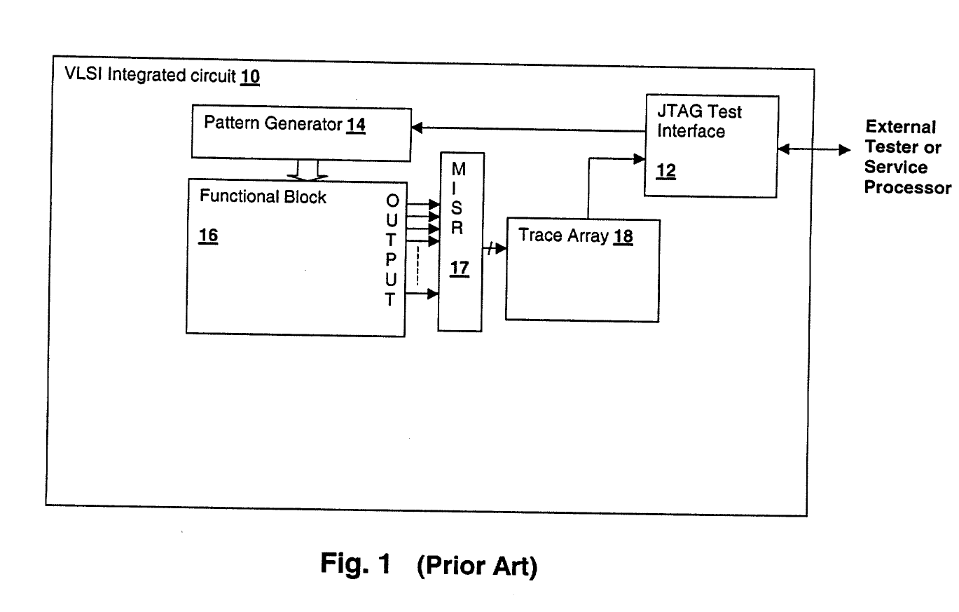

With reference now to the figures, and in particular with reference to FIG. 1, there is depicted a block diagram of a prior art test apparatus. A VLSI integrated circuit (IC) 10, exemplary of circuits disclosed the above-referenced U.S. Pat. No. 6,393,594 includes a multiple input storage register (MISR) 17 coupled to the outputs of a functional block 16 within IC 10. MISR 17, computes a progressive signature value from the outputs of functional block 16. A pattern generator 14 is used to provide a pseudo-random pattern of logical inputs to functional block 16, in order to exercise functional block through many logic states of the internal circuits. Test patterns are loaded into pattern generator 14 via a JTAG interface 12, but could also be provided by other means such as a bus interface or intelligent test port interface. Alternatively, test patterns are be generated by the hardware by including an embedded pseudo-random pattern generator within pattern generator 14.

The output of MISR 17 is connected to a trace array 18 which is used to capture multiple signatures. Trace array 18 can be read after pattern generation tests via a JTAG interface 12 and the signatures analyzed and compared to known signatures for the test patterns loaded into pattern generator 14. While the above-described circuit has been implemented for exercising functional block 16 at normal operational frequencies, it is generally only used within special test versions (debug versions) of IC 10, and further tests only the signature of output states of functional block 16. Therefore, the test capability of the apparatus of FIG. 1, does not test internal nodes other than the reflection of internal node performance on the output, and further, due to size limitations of pattern generator 14, only a relatively short pattern can be run. The length of the pattern is directly determinative of the ability to exercise functional block 16 through all states and sequences of states that may occur in actual operation, so that faults that will cause failure can be detected. There are faults that do not cause errors that may be present within functional block 16 that will be entirely missed by the apparatus of FIG. 1, however those faults may lead to performance degradation or early failure and it is desirable to detect internal faults that cannot be observed by the signature-gathering apparatus of FIG. 1.

The apparatus of FIG. 1 is also illustrative of the circuits disclosed in U.S. Pat. No. 6,311,311, which also discloses details of MISR architecture and operation and is therefore incorporated herein by reference. The above-referenced patent uses a MISR circuit to again observe the outputs of a functional block such as functional block 16 that are placed in architected registers by connecting MISR 17 to a logic XOR accumulator that accumulates changes over multiple architected registers within a processor. Rather than observing a pattern loaded via pattern generator 14, the outputs of functional block 16 are observed as an exerciser program is running a set of test instructions that change the values in the architected registers. The apparatus and method described in above-incorporated patent application can run larger patterns than the pattern generator 14 based apparatus, as the processor itself is executing code that may run from any memory coupled to the processor. However observation is made of only accumulated architected register states and a signature is produced only at each update to an architected register, limiting severely the ability to observe faults in the logic, especially those faults that do not result in an incorrect architected register state, yet result in degradation in performance, or are speculative and discarded results. Also, the observation is made in an order-independent and stall-independent manner, so observations of execution differences that lead to non-identical execution patterns that otherwise update architected registers with the same values will not be detected.

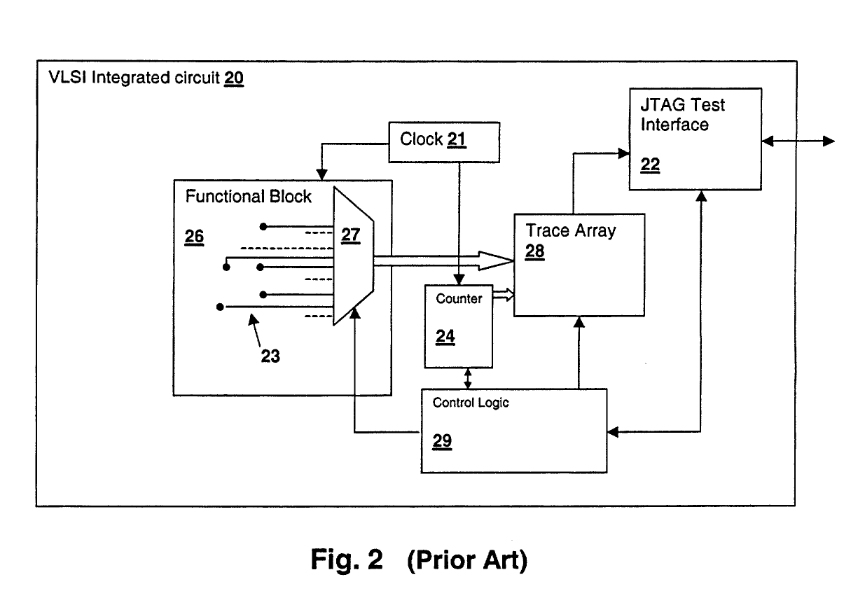

Referring now to FIG. 2, another prior art testing apparatus is depicted. A VLSI Integrated circuit 20, representative of circuits disclosed in published U.S. Patent applications US2002/0129300 and US2002/0178403, includes circuits implementing an internal logic analyzer for observing internal signals 23 of functional block 26. A multiplexer 27 selects sets of internal signal nodes from generally thousands of internal signal nodes 23, providing a “debug bus” output. While multiplexer 27 is not generally connected to every signal node within functional block 26, the number of observable signals and the fact that they are chosen by the IC 20 designer to represent signal nodes that will give the most valuable debug information when observer, yields a source of information that is very powerful for test and debug purposes. All critical control points are typically selectable at multiplexer 27, along with points in data paths that represent accessed storage values (prior to presentation at the output of storage units) and stored values (prior to write-strobing), that can provide valuable information about the performance of a logic unit/array unit interface boundary. The apparatus of FIG. 2 is also generally incorporated within the production version (as opposed to the debug version) of integrated circuit 20, as no large storage area is required and functional block 26 does not have to be isolated in order to perform functional observations.

However, the apparatus of FIG. 2 is a logic analyzer in form and function, not a lengthy-pattern analyzer. A counter 24 is used to load the selected signal node signal values into a trace array 28, that can be read via JTAG test interface 22 by a service processor, tester or other processing unit used for debugging. Alternatively, the results may be read via a bus or means other than the JTAG test port. A control logic 29 is used to select the signal nodes for observation via multiplexer 27 and to control counter 24 and trace array 28 such that trace array captures the selected signal node values at predetermined intervals determined by clock 21 and any division thereof programmed by control logic. Any test other than the most limited functional test is generally not performable with the apparatus of FIG. 2, as continuous readout and subsequent analysis of trace array 28 could only be performed at substantially reduced operating frequencies, while a non-continuous readout of trace array 28 is limited by the size of trace array.

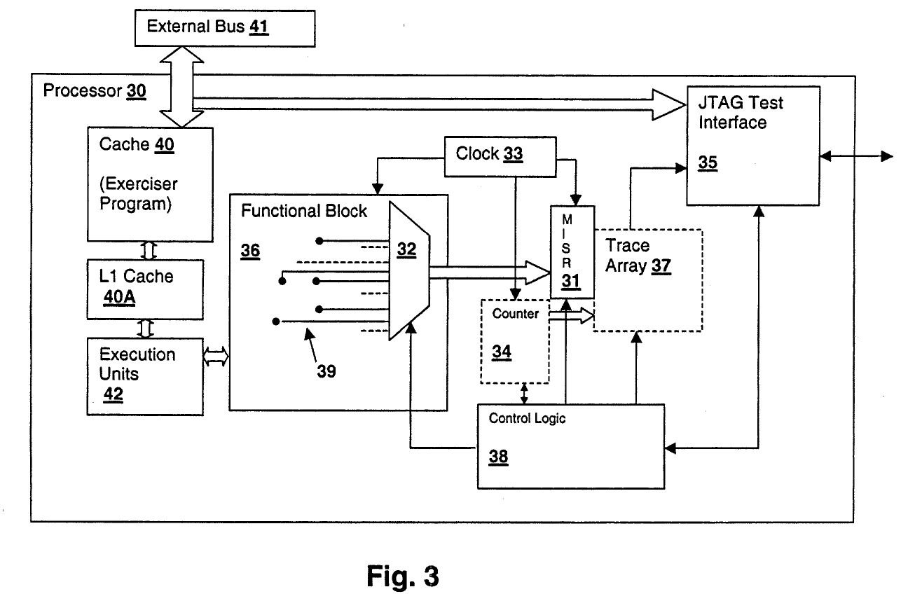

The present invention uses the internal node selection provided by the circuit of FIG. 2 in a novel fashion. Referring now to FIG. 3, a test apparatus within an integrated circuit in accordance with an embodiment of the present invention is shown. A processor 30 (which in other embodiments of the present invention may be another type of VLSI IC), includes functional block 36 from which internal signal nodes 39 are selected for observation via multiplexer 32. A memory within processor 30, which in the illustrative embodiment is an L2 cache 40 (in particular the L2 cache of a present-day processor having a size in excess of 0.5 megabyte) and cache 40 is coupled to execution units 42, generally via one or more L1 caches 40A. Execution units are coupled to functional block 36 for illustrative purposes, but in fact, functional block represents any of the actual execution units, storage units, bus management units, storage management units and other functional blocks within processor 30. In addition, each of the above execution, storage and control units include a unique multiplexer 32 and the test apparatus described below is generally replicated many times throughout processor 30 greatly increasing test throughput and observability of fault interaction between functional blocks.

The outputs of multiplexer 32 which are generally 64 or 128 bits wide, are provided to a trace array 37 that has been modified to incorporate a selectable MISR 31. By selectively activating MISR 31 functionality, a logic analysis apparatus is selectively transformed into a signature-gathering apparatus that in conjunction with a large exerciser program storage space (L2 cache 40) can provide greatly improved testing for internal logic faults and other circuit degradation. An exerciser program is loaded into L2 cache 40 via JTAG test interface 35 or an external bus 41 and signature-gathering is commenced synchronously with execution of the test program by placing processor 30 in a known state (generally a reset state) and commencing execution of the exerciser program. Prior to incorporation of large caches such as L2 cache 40, the length of the exerciser program and thus the number of unique instruction sequences that could be driven through functional block 36 were limited. The provision of a large cache in conjunction with the use of self-modifying or self-test-generating code almost indefinitely extends the number of instruction sequences that can be used to generate each signature used to verify/test processor 30.

Trace array 37 can be used to store signatures produced by MISR 31 at each clock cycle of a clock 33 that operates both the test apparatus (a trace array counter 34 and MISR 31) along with functional block 36. The common clock source provides cycle synchronous signatures at every clock cycle and the trace array 37 values can be optionally used to back trace to further determine the cause of a fault via the signature history. A control logic 38 is coupled to JTAG test interface 35 for selecting the active set of signal nodes and to counter 34, MISR 31 and trace array 37 for controlling the signature-gathering process. One or more signatures are read from MISR 31 and/or trace array 37 via JTAG interface 35, although as mentioned above, trace array 37 can be exposed to program code within processor 30 or over another external bus or test port to provide for reading out signatures. Only one signature, gathered at a predetermined point in the execution (generally the end of execution) of the exerciser program, is generally needed to determine whether or not a fault has occurred, as the test algorithms (code sequences) are chosen to minimize aliasing. Aliasing is a phenomenon wherein one or more faults cause the effective cancellation of an incorrect signature due to a first fault, rendering the probability of a correct signature being returned in the presence of a fault. The process may be repeated over all of the functional blocks within processor 30 for all sets of available signals from internal signal nodes 39, yielding a very high confidence level for parts that match all known good signatures for all tests.

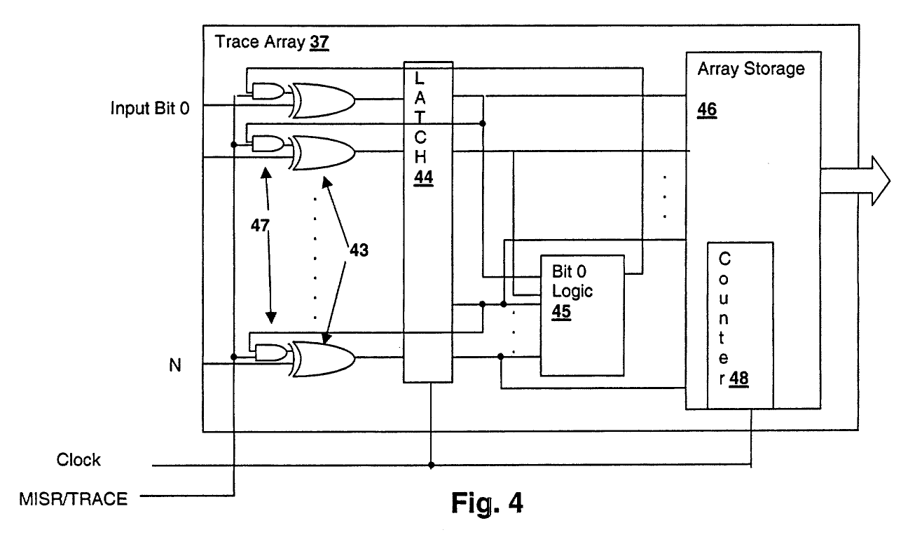

Referring now to FIG. 4, details of trace array 37 in accordance with an embodiment of the invention are depicted. Trace array 37, as depicted, includes MISR 31, but in other embodiments of the invention, MISR 31 may be located outside of trace array 37. The advantage of incorporating MISR 31 within trace array 37 is that the boundary (staging) latches at the input of trace array 37 can be easily converted into a MISR, so that the hardware cost of MISR addition is very low. A latch 44, having a width the width of MISR 31 and the debug bus output of multiplexer 32 is used to hold the signature value when trace array 37 is in MISR mode (MISR/TRACE signal=logical “1”). Logical AND gates 47 enable feedback signals from the output of latch 44 to a set of logical exclusive-OR gates 43 that compute the next signature value and provide it as inputs to latch 44. The feedback signals are taken from the next lower bit in the signature (except for the feedback coupled to the exclusive-OR gate providing the next bit 0, which is provided as primitive polynomial logic from carefully selected tap points of latch 44 bits. For a 64-bit latch 44, output word bits 0, 2, 3 and 63 are combined in a logical exclusive-OR to provide the bit 0 input signal, forming primitive polynomial 1+x+x³+x⁴+x⁶⁴. The combination is generated by logic 45. When trace array 37 is in trace mode (MISRITRACE signal=logical “0”), trace array 37 gathers trace values for use as the logic analyzer apparatus of FIG. 2 and latch 44 is used for input staging to provide proper timing of signal capture. Therefore, the prior functionality of trace array 37 is retained with a minimum of additional circuitry to add MISR functionality to the input latch 44 of trace array 37. Array storage 46 stores the trace (trace mode) or signature (MISR mode) values as sequenced by counter 48 can counter 48 and latch 44 are both clocked by Clock signal, which is connected to the clock that operates the functional block under test, providing cycle-synchronous signatures or traces, depending on the selected operating mode.

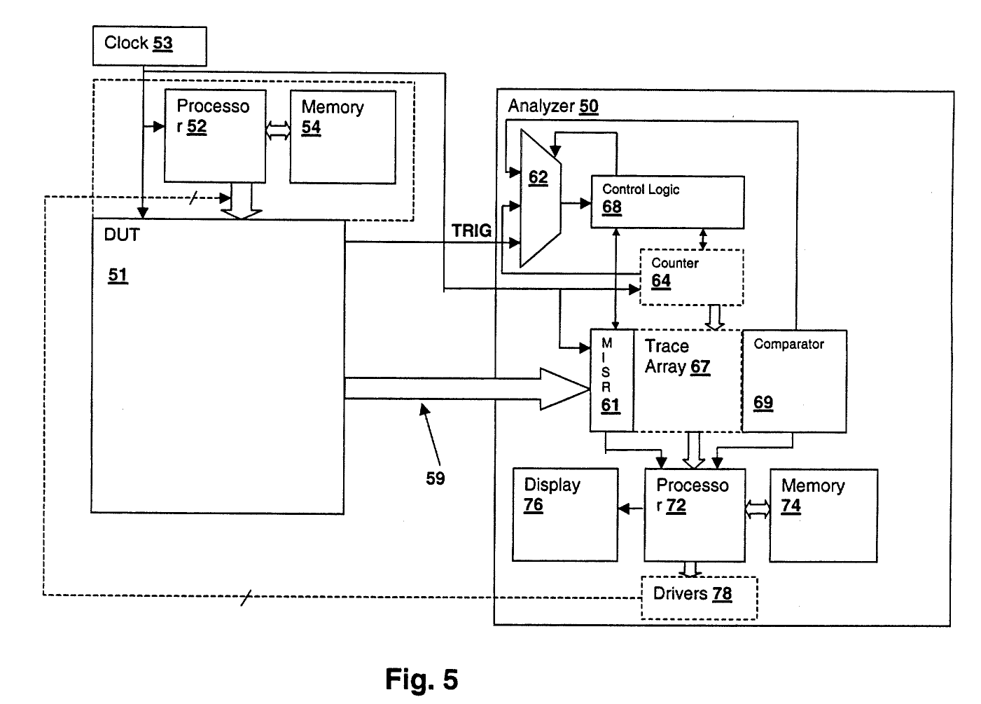

Referring now to FIG. 5, a test apparatus and variations in accordance with other embodiments of the present invention is shown. A device under test (DUT) 51 is coupled to a processor 52 and a memory 54 for providing stimulus in accordance with an exerciser program stored within memory 54 and executed by processor 52. Processor 52 and/or memory 54 may be located within DUT, as indicated by the dashed lines around the DUT 51 boundary. A clock 53 provides synchronous clocking of processor 52, optionally DUT 51 (which may not require an external clock) and an analyzer 50 in accordance with an embodiment of the present invention. DUT 59 is coupled to analyzer 50 via a plurality of signals and the interface may include a logic analyzer head with buffers, terminators and other circuits required to support remote sampling of signals provided from DUT 59.

The signals coupled from DUT 51 are input to a MISR 61 that generates a signature as execution of the exerciser program proceeds. An optional trace array 67 may be included to capture signatures generated by MISR 61 and may perform the selective trace mode/MISR mode functions of the trace array 67 of FIG. 4, providing traditional trace capability along with the MISR operation of the present invention. A comparator 69 may be included to compare the signature output of MISR for pass/fail determination by a processor 72, and/or for providing a trigger on a signature value via a multiplexer 62 that can select between a TRIG signal provided by DUT 51, a comparator 69 output, or a clock cycle counter 64 output value, causing control logic 68 to start and/or stop the generation of signatures. Comparator 69, multiplexer 62, control logic 68 and counter 64 can all be used in a “trace” mode to provide traditional logic analyzer trigger and capture functionality. Processor 72, memory 74 and display 76 are provided to illustrate a self-contained analyzer 50 functionality, but may be replaced by a bus connection to a general-purpose computer that provides analysis of the results of MISR and/or trace operation. Drivers 78 are optionally provided in accordance with yet another alternative embodiment of the invention in which stimulus to DUT 51 is provided directly from analyzer 50 from an exerciser program running from memory 74 and coupled to DUT 51 via drivers 78 and associated interconnect cables/test bed. If Analyzer 50 provides the stimulus DUT 51, the processor 52 and memory 54 are not required and clock 53 can be incorporated within analyzer 50.

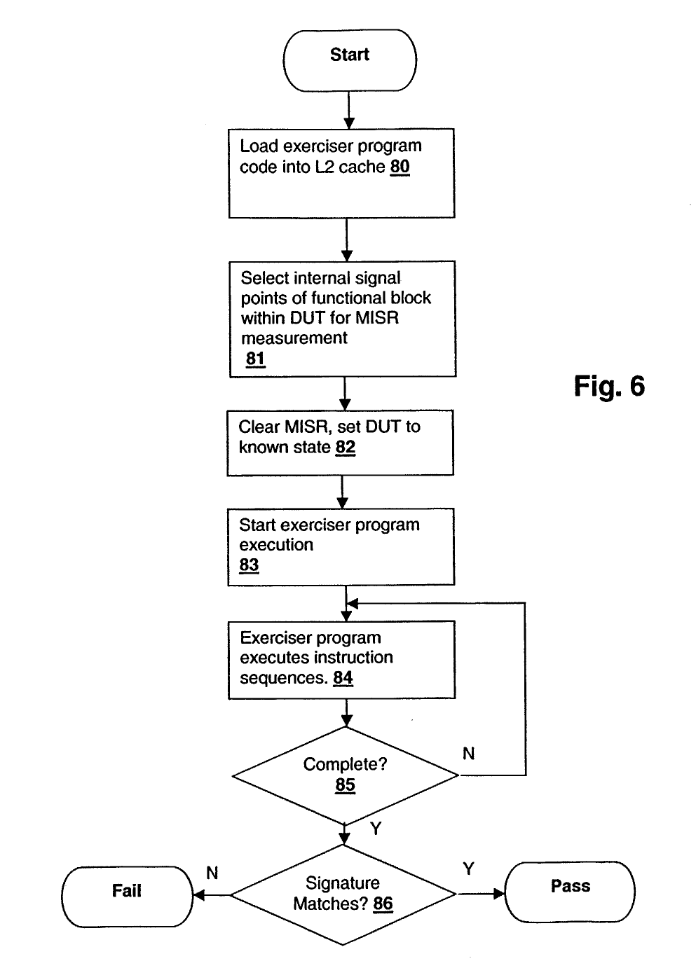

Referring now to FIG. 6, and also to FIG. 3, a method in accordance with an embodiment of the invention is illustrated in a flowchart. First, and exerciser program is loaded into L2 cache 40 (step 80) and internal signal points of functional block 36 are selected for MISR measurement (step 81). Next, MISR 31 is cleared and functional block 36 is set to a known (predetermined) state (step 82). Then, the exerciser program and signature collection is started (step 83). During program execution the exerciser program executes test pattern instruction streams (step 84) and may self-modify and/or generate code sequences on-the-fly. When execution is complete (or another stop trigger event occurs) (step 85) the signature is tested for a match to a known good signature (step 86), determining whether or not a part passes or fails. However, alternative uses extend testing for a known “bad” pattern, for example when trying to verify that a particular mask revision or lot contains a known fault, when attempting to determine that a fault has been fixed, or when tracing intermittent faults. Such bad pattern matching can be especially useful when a short exerciser program may be developed that generates a known bad signature very quickly on a particular known fault.

While the invention has been particularly shown and described with reference to the preferred embodiment thereof, it will be understood by those skilled in the art that the foregoing and other changes in form, and details may be made therein without departing from the spirit and scope of the invention.

What is claimed is:

1. A method for testing a logical circuit coupled to a processing element, said processing element further coupled to a memory for storing program instructions for execution by said processing element, said method comprising:
providing a clock signal to said processing element;
loading an exerciser program into said memory;
selecting a plurality of internal signal nodes of said logical circuit for observation;
executing said exerciser program;
collecting a multiple input shift register synchronous signature of logical values of said selected plurality of internal signal nodes at regular intervals of said clock signal, whereby said synchronous signature is obtained;
completing execution of at least a portion of said exerciser program;
in response to said completing, reading a completion signature from said multiple input shift register; and
determining whether or not said signature matches a known signature corresponding to said portion of said exerciser program, whereby functional operation said logical circuit in response to said exerciser program is evaluated.

2. The method of claim 1, wherein said collecting collects said signature at each clock cycle.

3. The method of claim 1, wherein said logical circuit is said processing element, and wherein said collecting collects a signature of said processing element.

4. The method of claim 1, wherein said processing element, said logical circuit and said memory are located within an integrated circuit, and wherein said loading loads said exerciser program into said memory within said integrated circuit.

5. The method of claim 1, wherein said executing further comprises generating streams of said program instructions, whereby said exerciser program self-modifies.

6. The method of claim 1, further comprising capturing said signature periodically into a trace buffer, whereby a history of said signature can be examined.

7. An apparatus for testing a logical circuit, said apparatus comprising:
a memory containing program instructions comprising an exerciser program, whereby states of said logical circuit are exercised in response to execution of said program instructions;
a processing element coupled to said memory for executing said exerciser program;
a clock coupled to said processing element for clocking internal states of said processing element;
a multiple input shift register (MISR) coupled to internal signal nodes of said logical circuit for collecting a synchronous signature of values of said signal nodes in response to execution of said exerciser program at regular intervals of said clock, whereby said synchronous signature is obtained; and
a comparison mechanism for comparing said collected signature of said signal nodes to a known signature, whereby functional operation said logical circuit in response to said exerciser program is evaluated.

8. The apparatus of claim 7, wherein said logical circuit is a functional unit within a processor integrated circuit, wherein said processing element is an execution unit within said processor, and wherein said MISR is located within said processor.

9. The apparatus of claim 8, wherein said memory is a cache within said processor.

10. The apparatus of claim 7, further comprising a trace buffer coupled to an output of said MISR, whereby multiple signatures are collected for observation.

11. The apparatus of claim 10, wherein said MISR is incorporated within an input latch of said trace buffer.

12. The apparatus of claim 11, further wherein said MISR includes a control input for selecting operation of said MISR as a multiple input shift register or a input value latch, whereby said trace buffer selectively captures one of said multiple signatures or states of said signal nodes.

13. The apparatus of claim 7, further comprising a multiplexer connected to a first plurality of internal signal nodes of said logical circuit, and coupled to said MISR for selecting a set of said internal signal node as inputs to said MISR, whereby said signature is collected for said selected set of signal nodes.

14. The apparatus of claim 7, wherein said program instructions further comprise program instructions for generating streams of said program instructions, whereby said exerciser program self-modifies.

15. The apparatus of claim 7, wherein said logical circuit is coupled to an analyzer, and wherein said MISR is located within said analyzer.

16. The apparatus of claim 15, wherein said processing element and said memory are located within said analyzer and further comprising a driver circuit coupled to said processing element for providing stimulus to said logical circuit by coupling signals from said processor to said logical circuit.

17. The apparatus of claim 15, wherein said processing element and said memory are located within said logical circuit, whereby said exerciser program executes within said logical circuit and said analyzer collects signatures of internal signal nodes of said logical circuit in conformity with internal execution of said exerciser program.

18. The apparatus of claim 15, further comprising a trace buffer within said analyzer and coupled to an output of said MISR, whereby multiple signatures are collected for observation.

19. The apparatus of claim 18, wherein said MISR is incorporated within an input latch of said trace buffer.

20. The apparatus of claim 19, further wherein said MISR includes a control input for selecting operation of said MISR as a multiple input shift register or a input value latch, whereby said trace buffer selectively captures one of said multiple signatures or states of said signal nodes.

21. A processor, comprising:
a memory containing program instructions comprising an exerciser program, whereby states of said functional units within said integrated circuit are exercised in response to execution of said program instructions;
a processing element coupled to said memory for executing said exerciser program;
a clock coupled to said processing element for clocking internal states of said processing element; and
a multiple input shift register (MISR) coupled to internal signal nodes of at least one of said functional units for collecting a synchronous signature of values of said signal nodes in response to execution of said exerciser program at regular intervals of said clock, whereby said synchronous signature is obtained.
